(19) United States
(12) Patent Application Publication
(10) Pub. No.: US 2004/0130075 A1
(43) Pub. Date: Jul. 8, 2004

(54) Method for manufacturing shoe sole with vacuuming processes

(76) Inventor: Yi Tai Wang, Taichung (TW)

Correspondence Address: Yi Tai Wang, P.O. Box 63-298, Taichung, 406, TW

(21) Appl. No.: 10/337,171

(22) Filed: Jan. 3, 2003

(51) Int. Cl. B29C 51/02; B29C 51/10

(52) U.S. Cl. 264/553; 264/571

(57) ABSTRACT

A method for manufacturing shoe soles includes preparing a mold device having a mold cavity formed by an inner peripheral portion for receiving materials to form the shoe soles. The materials are vulcanized and stirred and then disposed into the mold cavity of the mold device, and are then heated and melted to molten status. The mold cavity of the mold device is vacuumed to uniformly apply the materials into depressions of the inner peripheral portion of the mold device, and thus for allowing the molten materials to effectively form spatial patterns on the outer peripheral portion of the shoe soles.

### BACKGROUND OF THE INVENTION

1. Field of the Invention

The present invention relates to a method, and more particularly to a method for manufacturing shoe sole with vacuuming processes to form spatial patterns on the outer peripheral portion of the shoe sole.

2. Description of the Prior Art

Various kinds of typical methods or processes have been developed for manufacturing shoe soles, and comprise such as hot-pressing processes, mold injection processes, etc. For example, U.S. Pat. No. 5,465,507 to Schumacher et al., U.S. Pat. No. 5,586,354 to Chi, and U.S. Pat. No. 5,667,737 to Wittmann disclose three of the typical methods for manufacturing the shoe soles.

However, the above-described typical methods may only be used to manufacture the shoe soles that comprise no or few cavities or bulges or swellings formed or provided on the outer peripheral portion thereof, and may not be used to manufacture the shoe soles that comprise many cavities or bulges or swellings formed or provided on the outer peripheral portion thereof.

For example, while hot-pressing or mold injecting the plastic materials into the mold cavities of the typical mold devices, the sticky or melted plastic materials may not be easily flown and engaged into the corresponding depressions or recesses formed in the mold cavities of the mold devices.

The present invention has arisen to mitigate and/or obviate the afore-described disadvantages of the conventional methods for manufacturing shoe soles.

### SUMMARY OF THE INVENTION

The primary objective of the present invention is to provide a method for manufacturing shoe sole with vacuuming processes to form spatial patterns on the outer peripheral portion of the shoe sole.

In accordance with one aspect of the invention, there is provided a method comprising preparing a mold device having a mold cavity formed therein, and having an inner peripheral portion, preparing materials for forming shoe soles, vulcanizing the materials, stirring the materials, disposing the materials into the mold cavity of the mold device, heating and melting the materials, and vacuuming the mold cavity of the mold device, to uniformly apply the materials onto the inner peripheral portion of the mold device, and thus for allowing the molten materials to be effectively formed as the shoe soles to be manufactured.

The mold device is further provided with one or more depressions and/or one or more swellings in the inner peripheral portion thereof, the vacuuming process is provided for drawing the materials into the depressions of the mold device, and thus to form the spatial pattern on the outer peripheral portion of the shoe soles.

One or more heating members may further be provided and engaged into the mold device to heat the materials, and to melt the materials.

The mold device further provides one or more passages therein and communicating with the mold cavity of the mold device, a vacuum pump is further provided and coupled to the passages of the mold device to vacuum the mold cavity of the mold device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram illustrating processes of a method in accordance with the present invention;

FIG. 2 is a plan schematic view showing a machine for conducting the method in accordance with the present invention;

FIG. 3 is a partial cross sectional and partial exploded view illustrating the mold device for conducting the processes of the method;

FIG. 4 is a perspective view illustrating a shoe sole to be manufactured by the method in accordance with the present invention;

FIG. 5 is a bottom plan view of the shoe sole; and

FIGS. 6, 7 are side plan views illustrating the patterns to be formed on the outer peripheral portion of the shoe sole.

### DETAILED DESCRIPTION OF THE PREFERRED EMBODIMENT

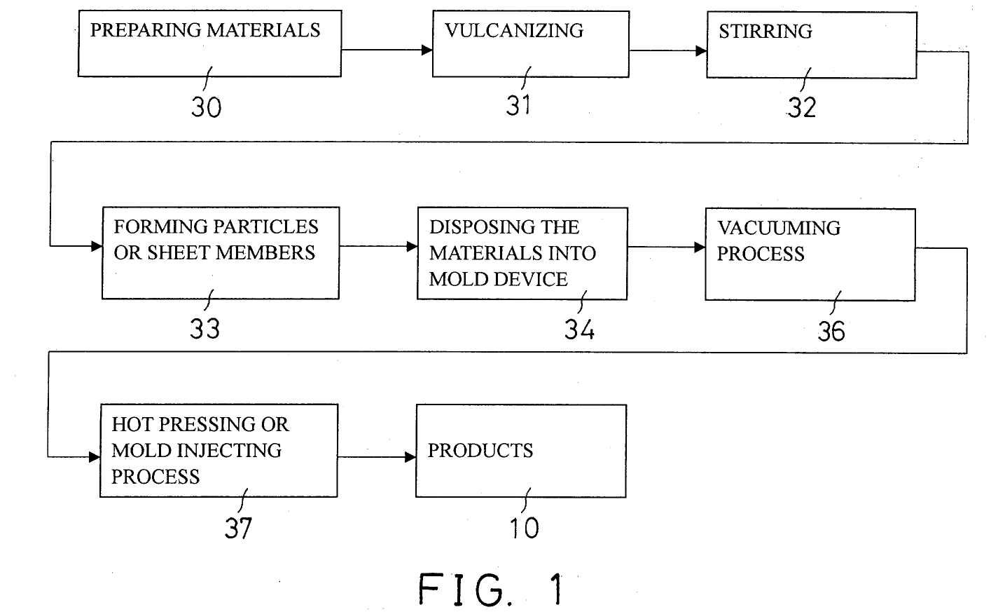

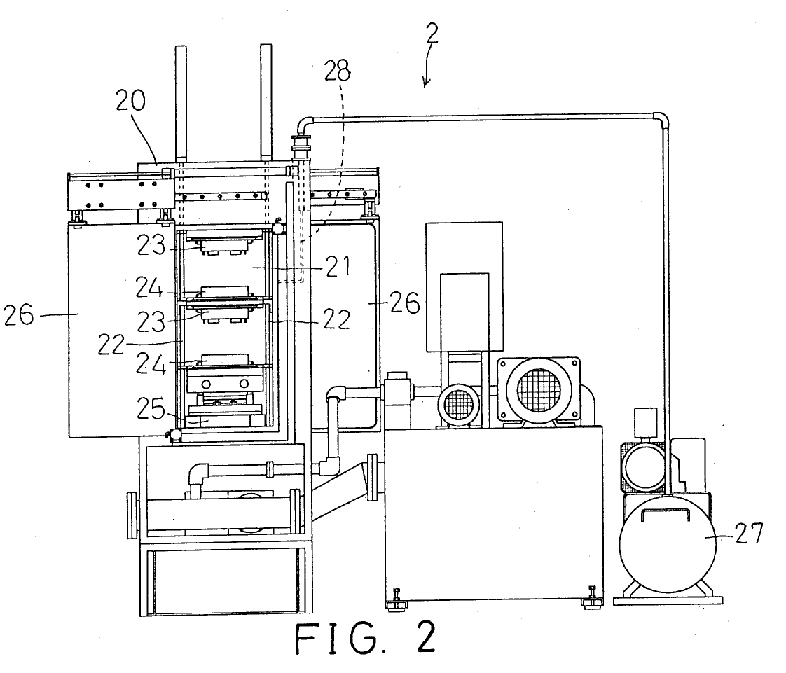

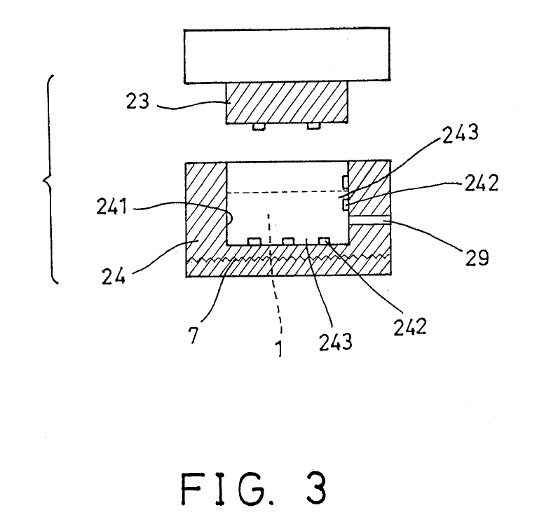

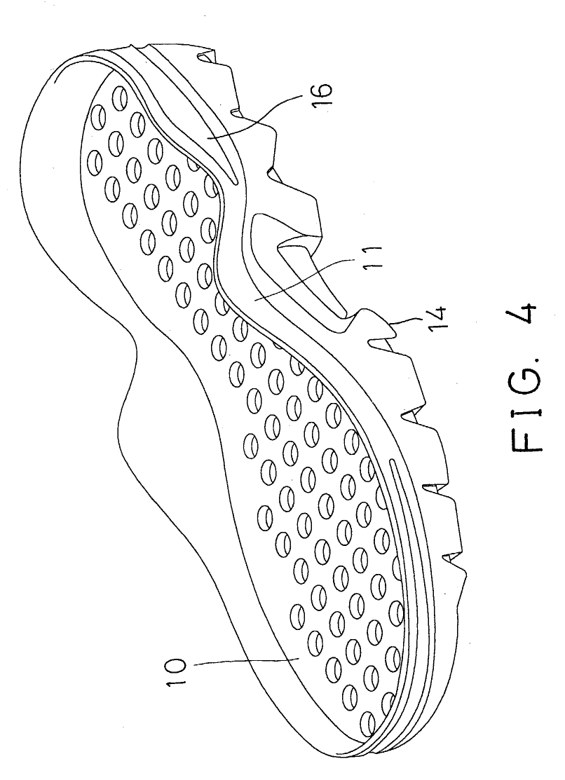

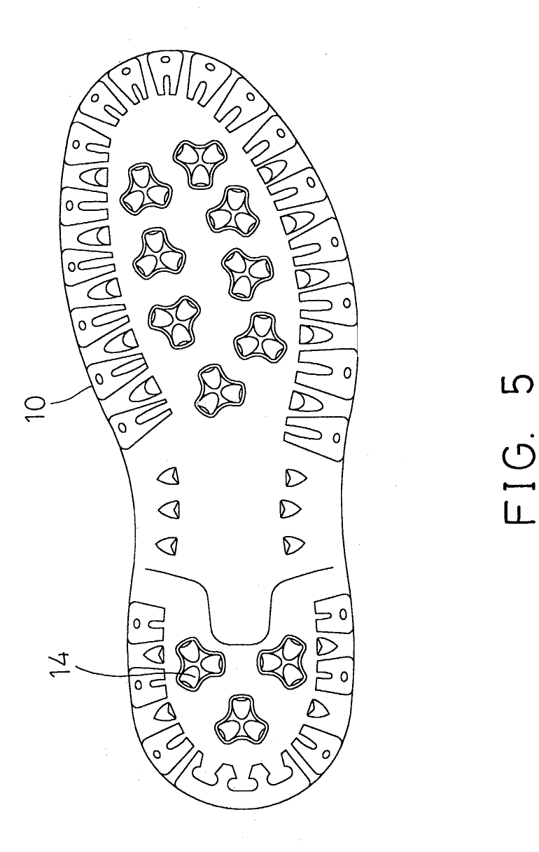

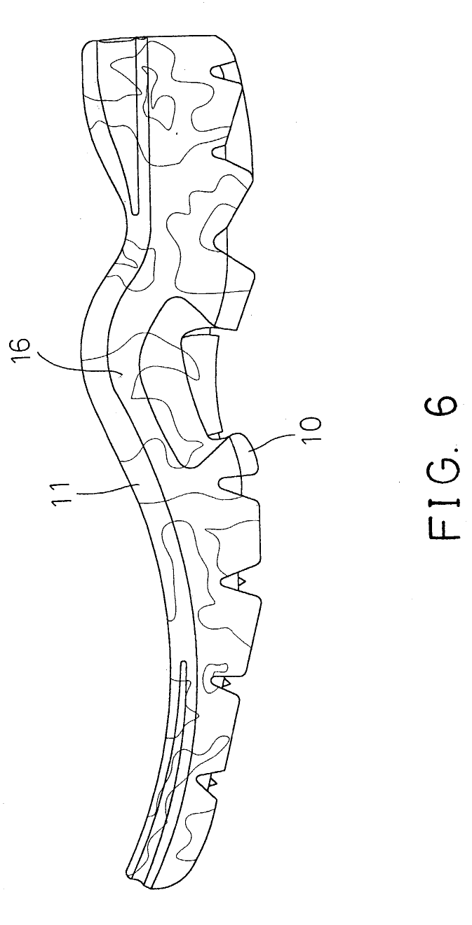

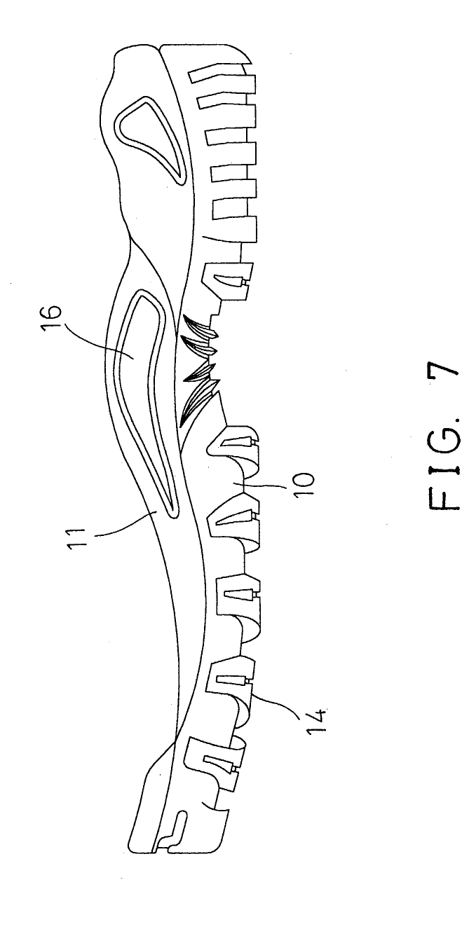

Referring to the drawings, and initially to FIG. 1, illustrated is the processes of a method in accordance with the present invention provided for manufacturing various patterns, such as planar patterns 16 (FIG. 6) or spatial patterns (FIG. 7) on outer peripheral portions 11 of shoe soles 10, or spatial patterns 14 on the bottom of the shoe soles 10 (FIGS. 4, 5). FIG. 2 shows a machine 2, and FIG. 3 shows a mold device for conducting the method in accordance with the present invention.

As shown in FIGS. 1-3, the method in accordance with the present invention comprises a first process 30 to prepare the plastic materials, synthetic materials or the like for manufacturing the shoe soles 10. The materials will then be vulcanized and/or colored in the following process 31, and then be blended or mixed with the other materials and/or be stirred in the process 32 to form a suitably blended material.

The suitably blended material will then be formed or shaped or mold injected into particles or sheet members 1 (FIG. 3) in the process 33, the particles or sheet members 1 will then be disposed into the mold cavity 241 of the mold device 23, 24, and will then be subjected with the vacuuming process 36 before subjected with a hot-pressing process or a mold injecting process 37 by the machine 2 (FIG. 2).

For example, as shown in FIG. 2, the machine 2 includes a chamber 21 formed or provided therein, one or more guide posts 22 vertically disposed in the chamber 21 thereof, and one or more mold devices 23, 24 slidably attached onto the guide posts 22, and movable up and down along the guide posts 22. An actuator 25, such as a pneumatic or hydraulic cylinder 25 is disposed below the mold devices 23, 24 for forcing the mold devices 23, 24 toward each other or to engage with each other.

For example, the mold devices 23, 24 each includes a lower mold piece 24 having a mold cavity 241 formed therein, for receiving the particles or sheet members 1 to be subjected with the vacuuming process 36 and the hot-pressing process or mold injecting process 37 (FIG. 1), and an upper mold piece 23 movable downwardly toward or to partially engage into the mold cavity 241 of the mold piece 24, and to engage with or press against the particles or sheet members 1.

The mold pieces 24 of the mold devices 23, 24 each includes one or more swellings 242 and/or depressions 243 formed in the inner peripheral portion thereof, for forming corresponding recesses or depressions or swellings or bulges or patterns 14, 16 on either the outer peripheral portion 11 or the bottom of the shoe soles 10.

The machine 2 includes one or more windows or doors 26 formed or provided therein, for disposing the particles or sheet members 1 into the mold cavity 241 of the mold device 23, 24, and/or for removing the products or the shoe soles 10 out of the mold devices 23, 24, and/or for examining or checking or repairing the mold devices 23, 24.

The mold pieces 24 of the mold devices 23, 24 each includes a passage 29 formed therein and communicating with the mold cavity 241 thereof. The machine 2 includes one or more tubes or flexible manifolds 28 coupled to the passages 29 of the mold devices 23, 24 respectively, and coupled to a vacuum pump 27 which may draw or vacuum the mold cavity 241 of the mold devices 23, 24 before the particles or sheet members 1 are subjected with the vacuuming process 36 and the hot-pressing process or mold injecting process 37 (FIG. 1).

It is to be noted that the particles or sheet members 1 will be melted into a sticky or molten status in the hot-pressing process, and/or may be injected or forced into the mold cavity 241 of the mold device 23, 24 in such as the mold injecting process 37. The vacuuming process 36 (FIG. 1) is provided for drawing the molten materials toward the inner peripheral portions of the mold pieces 24, or to be uniformly applied onto the inner peripheral portions of the mold pieces 24, particularly into the depressions 243 of the mold pieces 24, and thus for allowing the patterns 14, 16, particularly the spatial patterns 14, 16 to be suitably formed on the shoe soles 10.

As shown in FIG. 3, the mold device 23, 24 may further include one or more heating members 7 provided therein, such as disposed in the mold pieces 24, to heat and melt the particles or sheet members 1 that are received in the mold cavities 241 of the mold pieces 24, for allowing the molten materials to be suitably engaged into the depressions 243 of the mold pieces 24. The mold cavities 241 of the mold devices 23, 24 may also be vacuumed while heating or hot-pressing the particles or sheet members 1.

Accordingly, the method In accordance with the present invention may be provided for manufacturing shoe soles with vacuuming processes to effectively or solidly form spatial patterns on the outer peripheral portions of the shoe soles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method comprising:
preparing a mold device having a mold cavity formed therein, and having an inner peripheral portion,
preparing materials for forming shoe soles,
vulcanizing the materials,
stirring the materials,
disposing the materials into the mold cavity of the mold device,
heating and melting the materials, and
vacuuming the mold cavity of the mold device, to uniformly apply the materials onto the inner peripheral portion of the mold device.

2. The method as claimed in claim 1 further comprising providing at least one depression in the inner peripheral portion of the mold device, and said vacuuming process being provided for drawing the materials into said at least one depression of said mold device.

3. The method as claimed in claim 1 further comprising providing a plurality of depressions and a plurality of swellings in the inner peripheral portion of the mold device, and said vacuuming process being provided for drawing the materials into said depressions of said mold device.

4. The method as claimed in claim 1 further comprising providing at least one heating member in the mold device to heat the materials.

5. The method as claimed in claim 1 further comprising providing at least one passage in the mold device and communicating with the mold cavity of the mold device, and providing and coupling a vacuum pump to said at least one passage of the mold device to vacuum the mold cavity of the mold device.
